(19) United States
(12) Patent Application Publication
(10) Pub. No.: US 2026/0210755 A1
(43) Pub. Date: Jul. 23, 2026

(54) SOLAR-POWERED ELECTRONIC SCALE

(71) Applicant: Shenzhen Unique Scales Co.,Ltd., Shenzhen (CN)

(72) Inventor: HUAYUN YU, Shenzhen (CN)

(21) Appl. No.: 19/029,814

(22) Filed: Jan. 17, 2025

(51) Int. Cl. G01G 21/28; G01G 19/44; G01G 23/36; H02S 40/38

(52) U.S. Cl. CPC G01G 21/28; G01G 19/44; G01G 23/361; H02S 40/38

(57) ABSTRACT

The invention discloses a solar energy electronic scale, which comprises an upper panel, a lower panel and an energy storage component. The upper panel comprises a substrate on which a perspective window structure is provided for allowing light to pass between the upper panel and the lower panel to provide light energy for the energy storage component; No matter where the electronic scale is placed, as long as the solar panel gets light, light energy can be converted into electric energy, and electricity can be stored for the built-in battery, avoiding the disturbance of frequent battery change, and there is no need to reserve an external power interface for the lower panel. The design not only meets the needs of users to weigh at any time, but also improves the experience because no external interface is required. The external material interference is reduced and the weighing accuracy is improved.

### TECHNICAL FIELD

The present invent belongs to the field of electronic scale technology, especially involving a solar electronic scale.

### BACKGROUND

Existing electronic scales are widely used in the field of weighing measuring and displaying the weight of objects through built-in sensors and displays. However, traditional electronic scales consist of upper panels lower panels display components and sensing components in these designs the upper panel mainly serves as a simple flat structure for placing the object under test and transmits the weight information of the object to the display component through the sensing component for display unable to utilize light energy for self-charging.

### SUMMARY

The technical problem to be solved by this invent is to overcome the shortcomings of the existing technology and provide a solar electronic scale that can overcome the above problems or at least partially solve the above problems.

In order to solve the above technical problems, the basic conception of the technical solution adopted by this invent is:

A solar-powered electronic scale comprising an upper panel; a lower panel connected to the said upper panel; an energy storage component positioned between the said upper panel and the said lower panel; a display component for displaying various information externally; and an sensing component for detecting changes in the weight of the target object on the said upper panel and transmitting the weight information to the display component for display; wherein the said upper panel includes a substrate, and the substrate is provided with a viewing window structure that allows light to pass through the said upper panel and the said lower panel to provide light energy to the said energy storage component.

Preferably, the energy storage component includes a battery and solar panels, the bottom panel is convexly provided with a frame, the frame and the inner wall of the bottom panel together form an installation groove, the battery and solar panels are both installed in the installation groove and receive light energy through a transparent area, converting it into electrical energy to power the battery.

Preferably, at least two protective pads are set at the corresponding positions of the installation groove, these protective pads are placed between the lower panel and the solar panel, with their respective sides adhered to the lower panel and the solar panel respectively, collectively supporting the solar panel to maintain force balance when it is subjected to compression.

Preferably, the frame has a wiring hole, the inner wall of the frame is convexly provided with multiple ribs towards the installation groove, and the inner wall of the bottom panel is provided with a wiring channel. The wiring hole is used for connecting wires from the solar panel through the installation groove to the wiring channel.

Preferably, the display component includes a display panel and a control panel, the sensing component includes a support member and a sensor, the sensor is installed within the support member and electrically connected to the control panel respectively, the sensor is used to sense the weight of the target object placed on the upper panel when the support member carries it.

Preferably, the electronic scale also includes an induction switch module located between the upper panel and the lower panel, which is electrically connected to the control board for activating the opening and closing of the induction component through the control board. The induction switch module also comprises a capacitive sensing head and conductive cotton, with at least one capacitive sensing head mounted on the lower panel and electrically connected to the control board. The capacitive sensing head is a spring, and the conductive cotton is placed on the upper panel. When the upper panel carries a target object to be weighed, the conductive cotton can come into contact with the capacitive sensing head, causing a change in capacitance.

In an alternative embodiment, the electronic scale further includes a light sensing module and a detection module, which are respectively signal connected to the display component.

After adopting the above technical solution, this invent has the following beneficial effects compared to existing technologies: This invent achieves this through a viewing window structure opened on the substrate, which is designed to receive external light. This means that regardless of where the solar electronic scale panel is placed, as long as the solar panel can receive light, it can convert the received light energy into electrical energy, thereby providing power storage for the built-in battery. As a result, users do not need to frequently change batteries, nor do they need to reserve external interfaces on the bottom panel for charging external power sources at specific locations. This design not only meets users needs for weighing anytime and anywhere but also enhances the user experience. On the other hand, because the bottom panel does not require external interfaces, this reduces the likelihood of external substances entering the solar electronic scale panel, thereby improving the accuracy of weight measurement.

### BRIEF DESCRIPTION OF DRAWINGS

FIG. 1 is a schematic diagram of the overall structure of a solar electronic scale proposed in this invent;

FIG. 2 is a front view of a solar electronic scale proposed in this invent;

FIG. 3 is a schematic diagram of an exploded connection structure of a solar electronic scale proposed in this invent;

FIG. 4 is a schematic diagram of the upper panel structure in FIG. 1 of this invent;

FIG. 5 is a schematic diagram of the bottom panel structure in FIG. 1 of this invent;

FIG. 6 is a schematic diagram of the connection structure between the bottom panel and the frame in FIG. 1 of the present invent;

FIG. 7 is a schematic diagram of the display component structure in FIG. 5 of this invent;

FIG. 8 is a schematic diagram of the structure of the sensing component in FIG. 5 of this invent;

FIG. 9 is a partial enlarged structural diagram at A in FIG. 5 of the present invent.

FIG. 11, Top Plate; 1111, Base Plate; 1112, Coating; 1113, First Perspective Area; 1114, Second Perspective Area; 1131, Decorative Line; 12, Bottom Plate; 1121, Installation Slot; 1122, Frame; 1123, Wiring Channel; 13, Display Component; 132, Display Board; 131, Control Board; 133, Fixing Part; 14, Sensing Component; 141, Sensor; 142, Support Part; 15, Energy Storage Component; 151, Battery; 152, Solar Panel; 16, Sensing Switch Module; 161, Capacitor Sensing Head.

### DESCRIPTION OF EMBODIMENTS

The following description of the present invent is further detailed in combination with the drawings and embodiments, so that the technical personnel in this field can refer to the description to implement it.

It should be understood that the terms used in this paper, such as “having”, “including” and “includes”, do not exclude the existence or addition of one or more other elements or their combinations.

In the description of this invent, the terms “transversely”, “vertically”, “up”, “down”, “front”, “back”, “left”, “right”, “upright”, “horizontal”, “top”, “bottom”, “inside”, “outside”, etc., indicating directions or positional relationships, are based on the directional or positional relationships shown in the drawings, and are only for the convenience of describing this invent and simplifying the description. They do not indicate or imply that the devices or components referred to must have specific directions, be constructed or operated in specific directions, and therefore should not be interpreted as limitations on this invent.

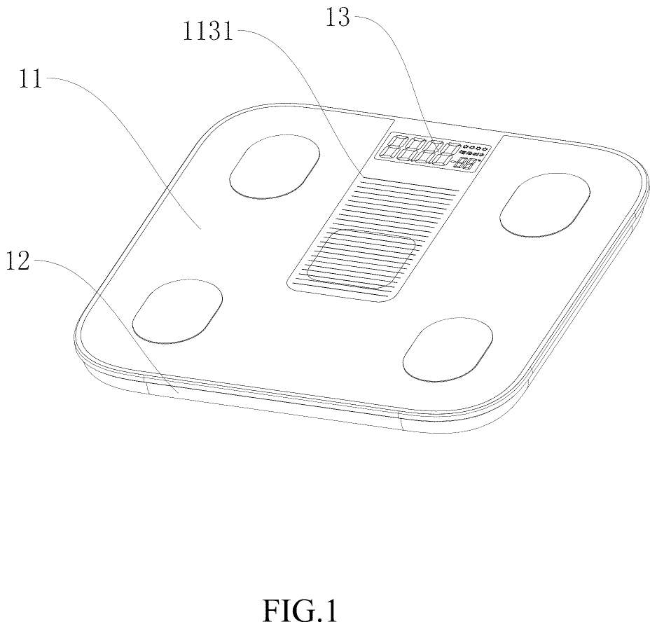

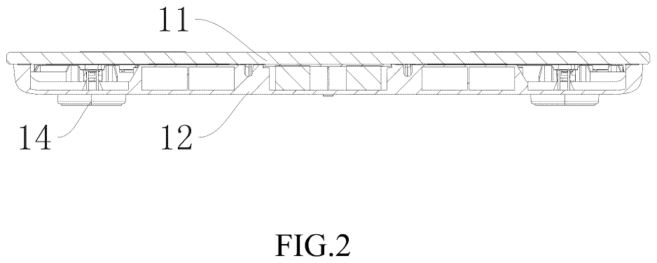

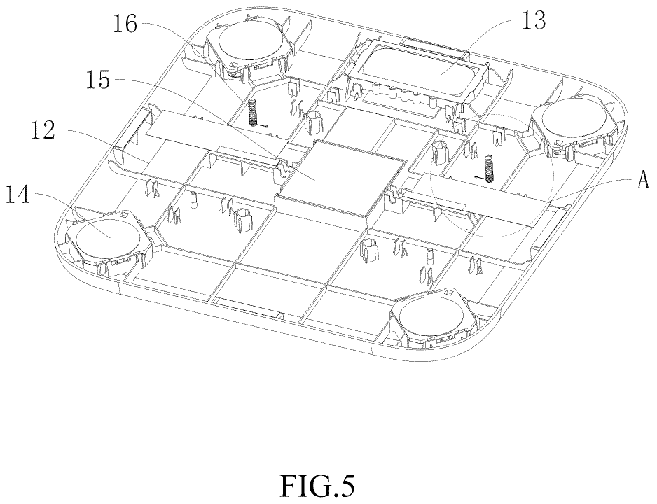

Referring to FIG. 1-FIG. 5, a solar electronic scale comprises a top panel 11 and a bottom panel 12 connected to the top panel 11, which can be clamped or bonded to the bottom panel 12 in other suitable ways.

In this embodiment, the energy storage component 15 is set between the upper panel 11 and the lower panel 12, including a battery 151 and a solar panel 152. The lower panel 12 is convexly provided with a frame 1122, which together with the inner wall of the lower panel 12 forms an installation groove 1121. Both the battery 151 and the solar panel 152 are installed in the installation groove 1121 and receive light energy through the transparent area, converting it into electrical energy to power the battery 151. The upper panel 11 includes a substrate 1111, on which a transparent window structure is set to allow light to pass through between the upper panel 11 and the lower panel 12, providing light energy for the energy storage component 15.

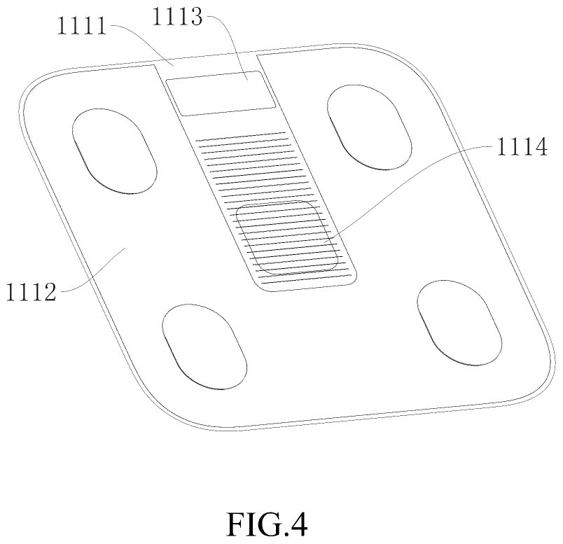

Referring to FIG. 4, the perspective window structure includes a first perspective area 1113 and a second perspective area 1114, which are independently located on substrate 1111, or the first perspective area 1113 and the second perspective area 1114 are connected to form an integral perspective surface. The second perspective area 1114 corresponds to the solar panel 152 installed in slot 1121. The areas of the second perspective area 1114 and the first perspective area 1113 can be equal, or the area of the second perspective area 1114 can be greater than or less than that of the first perspective area 1113. Of course, the shape of the second perspective area 1114 can be consistent with or inconsistent with the shape of the solar panel 152.

In addition, at the corresponding position of the second perspective area 1114, multiple decorative lines 1131 are arranged side by side on the inner wall of the substrate 1111. The advantage of this design is that, on one hand, setting up multiple decorative lines 1131 on the substrate 1111 mimics the splicing lines on the solar panel 152, allowing consumers to clearly distinguish between the solar electronic scale and traditional electronic scales when purchasing the product, thereby facilitating market promotion and the rapid transformation of user usage habits.

Among them, to better facilitate user identification, the imitation solar panel 152s splicing wires are arranged horizontally or vertically parallel. On the other hand, regardless of where the solar electronic scale panel is placed, as long as its solar panel 152 receives light, it can convert the received light into electrical energy and then convert this electrical energy into electrical power to supply the battery 151, allowing the battery 151 to store spare electrical energy or provide real-time power to components such as the display module 13 and the sensing module 14, thus eliminating the need for frequent battery 151 replacements and enhancing the user experience.

In practical applications, substrate 1111 can also be made of transparent materials such as glass, for example, a glass panel. To prevent people from directly observing the components inside the housing cavity which could affect aesthetics, and also to prevent sunlight from directly shining through the substrate 1111 onto the various components inside the housing cavity accelerating aging, a coating 1112 is set on the inner wall of substrate 1111. The coating 1112 can be a sun protection coating 1112 or other shielding coatings 1112, and the coating 1112 is at least one layer or multiple layers of coatings 1112 can be stacked together.

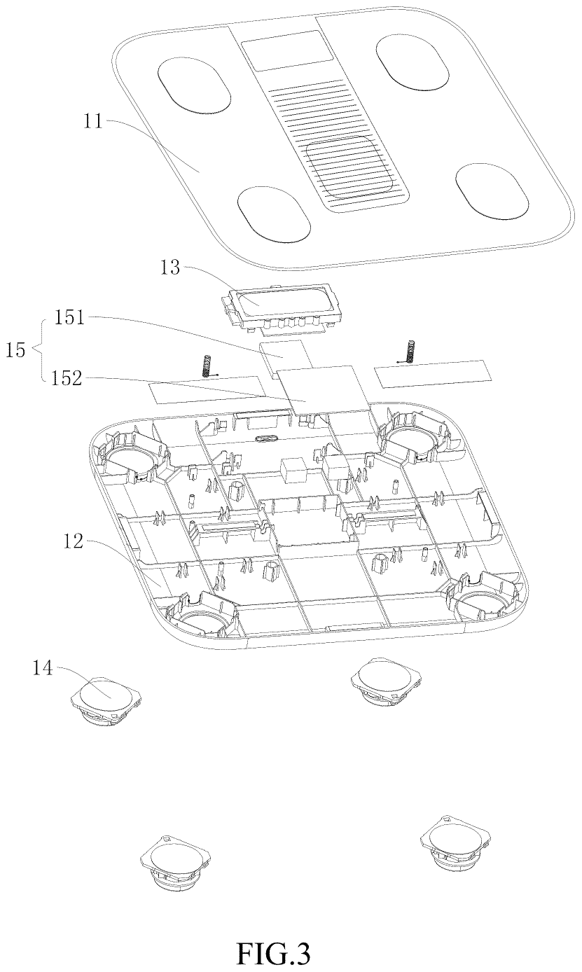

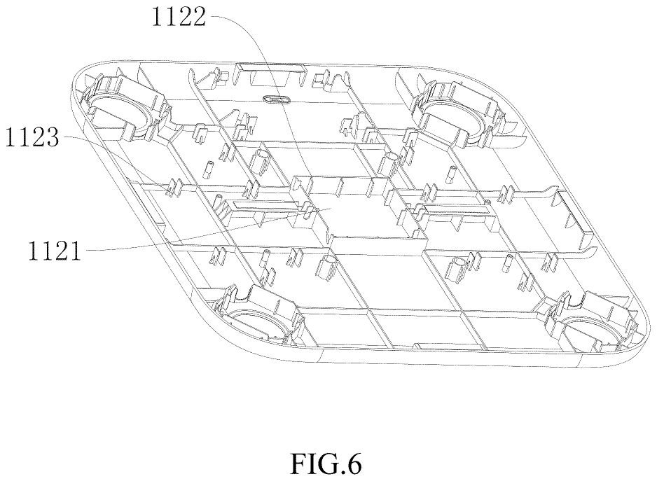

Referring to FIGS. 3 and 6, at least two protective pads are set at the corresponding positions of installation groove 1121, positioned between the lower panel 12 and the solar panel 152. The protective pads are respectively adhered to the lower panel 12 and the solar panel 152 on their relative sides, collectively supporting the solar panel 152 to maintain force balance when compressed. When the solar electronic scale collides, the flexible protective pads can support the solar panel 152, reducing its movement and providing cushioning and protection for the solar panel 152, thus preventing damage to the solar panel 152. Of course, in other embodiments, the protective pads can be connected to the lower panel 12 and the solar panel 152 in other suitable ways.

Referring to FIG. 3, a wiring hole is provided on the frame 1122, which can be circular, rectangular, etc., and is not limited here; it can be selected according to specific implementation. Multiple protrusions are set on the inner wall of frame 1122 facing the installation groove 1121. When the solar panel 152 is in use, it will emit heat, and the solar panel 152 can dissipate this heat through the protrusions to achieve heat dissipation. The inner wall of the lower panel 12 is equipped with a wiring channel 1123, and the wiring hole is used for connecting wires from the solar panel 152 to the wiring channel 1123 via the installation groove 1121, facilitating wiring and securing of wires to prevent messy wiring issues and making it easier for later maintenance and inspection of the wiring.

Specifically, in this embodiment, the wiring channel 1123 includes first slot walls and second slot walls, which cooperate with each other to achieve the fixation of wiring components. The number of wiring channels 1123 can be arbitrary and can be changed according to user requirements. In specific implementation, the wiring components connected to the solar panel 152 pass through the wiring holes on the installation slot 1121 and are routed into the wiring channel 1123, connecting to various components along the wiring channel 1123.

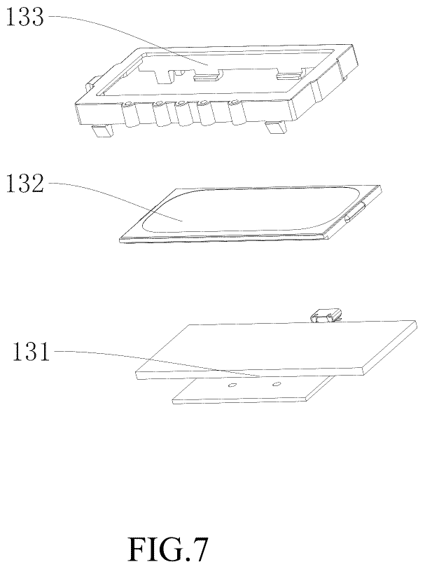

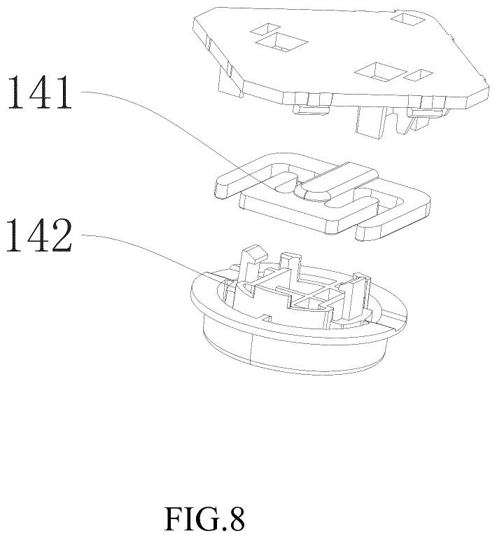

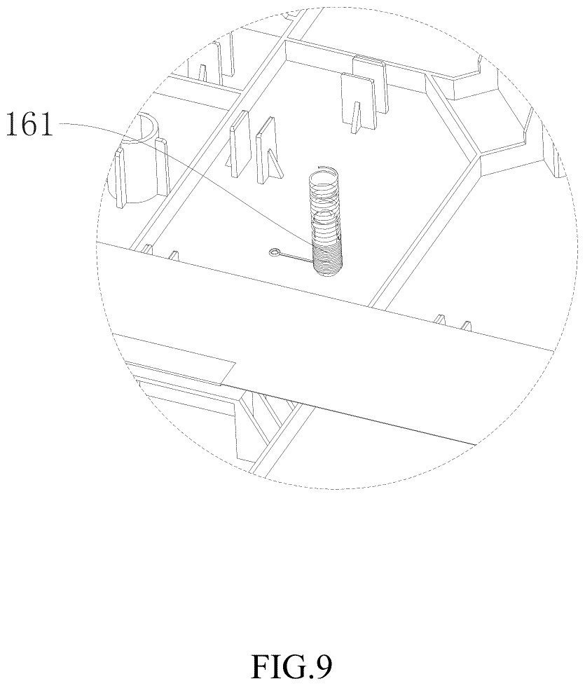

Referring to FIGS. 1-9, the present invention also provides an electronic scale comprising a top panel 11; a bottom panel 12 connected to the top panel 11; a display component 13 for displaying various information externally; and an sensing component 14 for sensing changes in the weight of the target object on the top panel 11 and transmitting the weight information to the display component 13 for display.

In practical applications, people can read various information from the display component 13 through the upper panel 11 or the first perspective area 1113 on the upper panel 11.

It should be noted that the “various information” referred to here includes but is not limited to weight, body mass index (BMI), outdoor temperature, light intensity and other information.

In this embodiment, the display component 13 includes a display board 132 and a control board 131, the display board 132 is installed on the bottom panel 12, the sensing component 14 includes a support piece 142 and a sensor 141, the support piece 142 is installed between the top panel 11 and the bottom panel 12, another part of the support piece 142 passes through the bottom panel 12 and can contact the support plane, in short, part of the support piece 142 protrudes from the bottom of the bottom panel 12, the sensor 141 is installed inside the support piece 142 and is electrically connected to the control board 131 respectively, the sensor 141 is used to sense the weight of the target object placed on the top panel 11 when the support piece 142 carries it, the control board 131 is connected to battery 151 and the sensing component 14 respectively through wires, it can be understood that when the display component 13 operates, battery 151 provides electrical power to the control board 131, display board 132, sensor 141, and other power-consuming components, the control board 131 can control the turn-on or turn-off of the display board 132, thus enabling the display component 13 to display various information externally for users to read.

Specifically, in this embodiment, the display component 13 also includes a mounting bracket 133, which is connected to the lower panel 12. The display board 132 is installed inside the mounting bracket 133, thereby achieving the installation and protection of the display board 132. At the corresponding position of the first perspective area 1113, the display board 132 is close to the upper panel 11, allowing the display component 13 to transmit various information to the outside world through the display board 132 for users to read via the first perspective area 1113.

To enable the solar electronic scale to quickly respond and enter operation, the electronic scale also includes an induction switch module 16 located between the top panel 11 and the bottom panel 12, which is electrically connected to the control board 131 for activating the opening and closing of the induction component 14 through the control board 131. The induction switch module 16 also comprises a capacitive sensing head 161 and conductive cotton, with at least one capacitive sensing head 161 installed on the bottom panel 12 and electrically connected to the control board 131. The capacitive sensing head 161 is a spring, while the conductive cotton is placed on the top panel 11. When the top panel 11 carries the target object to be weighed, the conductive cotton can come into contact with the capacitive sensing head 161, causing a capacitive change in the capacitive sensing head 161.

In this specific embodiment, the number of capacitive sensors 161 is two, and the two capacitive sensors 161 are connected in series and electrically connected to the pins of control board 131 and battery 151. Additionally, conductive cotton is placed on the side of the upper panel 11 facing the solar panel 152, where the conductive cotton can be installed on the upper panel 11 by means such as adhesive. For example, the conductive cotton is a thin sheet made of conductive material, using aluminum, copper, or other conductive materials, and can also be other structures or types of conductive cotton.

Specifically, in this embodiment, the conductive cotton is preferably an aluminum film, which is attached to the upper plate 11, and in other embodiments, the aluminum film can also be fixed by other means, which can be selected according to the implementation.

It should be noted that when the upper panel 11 carries the target weight, the conductive cotton can come into contact with the spring, causing the spring to deform under pressure and thus change capacitance. The control board 131 can then control the opening of the sensing component 14 based on the signal from the capacitive sensor head 161. When the target weight on the upper panel 11 is removed, the conductive piece no longer contacts the spring, which returns to its original state, causing a change in capacitance. Consequently, the control board 131 can also control the closing of the sensing component 14 based on the signal from the capacitive sensor head 161.

The solar electronic scale also includes an optical sensing module for obtaining the current light intensity (not shown in the figure). The optical sensing module is connected to the display component 13 by signal, so that the solar electronic scale can obtain the current light intensity and display the light intensity level on the display board 132, so that users can know the convenient charging position to meet the charging needs of the weight scale.

In addition, since battery 151 can achieve the power consumption balance supply of power-consuming components through solar panel 152 and power management circuit, the bottom panel 12 does not need to reserve external interfaces for charging from external power sources. This not only further facilitates users in weighing anytime and anywhere but also reduces the likelihood of external substances entering the housing. Considering the stress concentration issues during the manufacturing of the bottom panel 12, it can significantly increase the compressive strength of the bottom panel 12, thereby ensuring the stability and reliability of the overall structure of the solar electronic scale, especially its internal structure, ultimately improving the accuracy of weight measurement.

It should be noted that when the solar-powered electronic scale is in a non-operational state (specifically, not in the weighing state) and the battery 151 is not fully charged, the solar panel 152 can promptly convert the received light into electrical energy, which is ultimately converted into electricity and then delivered to the battery 151 for storage, ensuring that the solar-powered electronic scale remains or approaches full charge before the next weighing. If the battery 151 is not fully charged before the next weighing, it can also be charged appropriately during the weighing process to ensure the power consumption balance of the power-consuming components and prevent issues such as insufficient power supply leading to non-functioning.

The above embodiments only express several implementation methods of this invent, their descriptions are relatively specific and detailed, but this does not mean that they are intended to limit the scope of the invention patent. It should be noted that for ordinary technical personnel in this field, without departing from the conception of this invent, a number of variations and improvements can be made, all of which are equivalent modifications and developments based on the substantive technology of this invent. These all fall within the scope of protection of this invent.

What is claimed is:

1. A solar electronic scale characterized in that it comprises:
Top panel (11);
The below panel (12) is connected to the above panel (11);
Energy storage components (15) are disposed between the upper panel (11) and the lower panel (12);
Display components (13) for displaying various information to the outside;
Induction component (14), used to sense the weight change of the target weighing object on the above panel (11), and transmit the weight information to the display component (13) for display;
The above panel (11) includes a substrate (1111), and the substrate (1111) has a periscope window structure thereon, which allows light to pass through the above panel (11) and the below panel (12) to provide light energy for the energy storage component (15).

2. The solar-powered electronic scale according to claim 1, characterized in that the energy storage component (15) comprises a battery (151) and a solar panel (152), the bottom panel (12) is convexly provided with a frame (1122), the frame (1122) and the inner wall of the bottom panel (12) together form an installation groove (1121), the battery (151) and the solar panel (152) are both installed within the installation groove (1121), and they receive light energy through a transparent area, convert it into electrical energy, and supply power to the battery (151).

3. According to the solar electronic scale of claim 2, characterized in that at least two protective pads are provided at the corresponding positions of the installation groove (1121), the protective pads are set between the lower panel (12) and the solar panel (152), the relative sides of the protective pads are respectively adhered to the lower panel (12) and the solar panel (152), collectively supporting the solar panel (152) to maintain force balance when the solar panel (152) is subjected to compression.

4. According to the solar electronic scale as described in claim 2, the characteristic lies in that the frame (1122) has a wiring hole, the inner wall of the frame (1122) facing the mounting groove (1121) is provided with multiple protruding ribs, and the inner wall of the lower plate

(12) is equipped with a wiring channel (1123), the wiring hole is used for the wires connected to the solar panel (152) to pass through from the mounting groove (1121) to the wiring channel (1123).

5. According to the solar electronic scale of claim 1, the characteristic lies in that the display component (13) comprises a display board (132) and a control board (131), the sensing component (14) comprises a support member (142) and a sensor (141), the sensor (141) is installed within the support member (142) and electrically connected to the control board (131), the sensor (141) is used to sense the weight of the target load placed on the upper plate (11) when the support member (142) carries the target load.

6. According to the solar electronic scale of claim 5, the characteristic lies in that the electronic scale further comprises an induction switch module (16) disposed between the upper panel (11) and the lower panel (12), the induction switch module (16) electrically connected to the control board (131), for enabling the opening and closing of the induction component (14) through the control board (131). The induction switch module (16) also includes a capacitive sensing head (161) and conductive cotton, at least one of the capacitive sensing heads (161) is mounted on the lower panel (12) and electrically connected to the control board (131). The capacitive sensing head (161) is a spring, and the conductive cotton is set on the upper panel (11). When the upper panel (11) carries a target object to be weighed, the conductive cotton can come into contact with the capacitive sensing head (161), causing a change in capacitance at the capacitive sensing head (161).

7. A solar electronic scale according to claim 5, characterized in that the electronic scale further comprises a light sensing module and a detection module, the light sensing module and the detection module being respectively signal connected to the display component (13).
